(19) United States
(12) Patent Application Publication
(10) Pub. No.: US 2003/0175471 A1
(43) Pub. Date: Sep. 18, 2003

(54) Method for preparing a glass spacer ring for a magnetic disk and spacer ring

(75) Inventor: Masami Kaneko, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Asahi Glass Company, Limited, Tokyo (JP)

(21) Appl. No.: 10/385,851

(22) Filed: Mar. 12, 2003

(30) Foreign Application Priority Data
Mar. 18, 2002 (JP) 2002-074770

(51) Int. Cl. B32B 3/02

(52) U.S. Cl. 428/66.4; 65/404

(57) ABSTRACT

A glass spacer ring is prepared into a round slice from a glass tube having an outer diameter and a wall thickness corresponding to an outer diameter and a width of the spacer ring, respectively, by engraving a cutting line 7 on an inner side of a glass tube with a cutter in a direction perpendicular to a tubular axis thereof at a cutting interval corresponding to the thickness of a space ring, and heating the cutting line 7 with a burner from an outer side of the glass tube to cut the glass tube by heat shock.

### BACKGROUND OF THE INVENTION

1. Field of the Invention

The present invention relates to a method for preparing a glass spacer ring for a magnetic disk, a spacer ring prepared by the method and a magnetic disk drive including the spacer ring.

2. Discussion of Background

A magnetic disk drive, which has been used as a media unit, secures a plurality of hard disks or magnetic disks 11 between a flange 14 and a clamp 17 by alternately mounting the magnetic disks 11 and spacer rings 5 to a mounting shaft 15 with the flange 14 in stacked fashion, putting a shim 16 on the top magnetic disk 11 and tightening the clamp 17 on the shim by bolts 18 as shown in FIG. 5. When the magnetic disks are rotated by a rotary shaft of an electric motor, magnetic heads 12 read or write information, moving above the magnetic disks in floating fashion.

Each of the magnetic disks has a magnetic film formed on a substrate thereof. As the material for the substrate, there have been known aluminum, glass, ceramics and the like, though only aluminum and glass are put into practical use. As the material for the spacer rings, there have been known metal, such as aluminum and stainless steel, glass and ceramics. What is important to the magnetic disks is that the distance between a magnetic disk and its related magnetic head becomes as small as possible to record information in high-density and high-capacity. From this viewpoint, the magnetic disks are extremely required to have flatness and surface smoothness. Hard glass with good flatness is extremely superior to an aluminum substrate as the substrate for a magnetic disk since that sort of glass can effectively obtain required surface flatness and is adapted for a reduction in weight and size.

When the magnetic disks 11, the mounting shaft 15, the spacer rings 5 and the like in the magnetic disk drive are different from each other in terms of the thermal expansion coefficient of the materials thereof, a thermal expansion difference is created by a temperature difference between the operating time and the non-operating time, and a magnetic disk 11 is distorted by a strong external force given by its related spacer ring 5. When the magnetic disk 11 is distorted, there is a possibility that the presence of distortion in a radial direction makes a position error with respect to information to be read, making an error due to incorrect reading. When the degree of distortion becomes great, there is a possibility that the magnetic head 12 related to the magnetic disk 11 gets in contact with the surface of the magnetic disk to damage the magnetic film.

In order to cope with these problems, the magnetic disks 11 and the spacer rings 5 need to accord with each other in terms of thermal expansion coefficient to avoid the distortion due to a thermal expansion difference. From this viewpoint, it has been proposed that aluminum spacer rings be used for magnetic disks with an aluminum substrate, and that spacer rings made of ceramics having a thermal expansion coefficient approximate to that of glass or made of glass be used for magnetic disks with a glass substrate. Additionally, it has been known several method for producing a spacer ring made of glass.

Specifically, JP-A-10-074350 (corresponding to U.S. Pat. No. 5,760,999) discloses that a spacer (corresponding to a spacer ring according to the present invention) is made of glass. This publication also discloses a method for producing a spacer made of glass, wherein molten glass is poured into a mold with an annular internal space to be formed as a glass ring-shaped member, the ring-shaped member has both surfaces as contacting surfaces with media (corresponding to magnetic disks recited in the present invention) polished to have required flatness and parallelism, and then, the glass ring-shaped member has an electrically conductive film formed thereon after washing glass powder generated in the polishing operation.

There has been known another method for producing a glass spacer, wherein a core drill in a double structure, which has drill diameters corresponding to the inner and outer diameters of a spacer for instance, is used to cut out a glass ring-shaped member from a glass sheet having a wall thickness corresponding to the thickness of the spacer, and the glass ring-shaped member is subjected to polishing of the inner and outer peripheral surfaces and chamfering of the edges of the inner and outer peripheral surfaces.

Additionally, it has been disclosed in JP-A-9-44969 (corresponding to U.S. Pat. No. 6,215,617) that the material of a spacer is selected in accordance with the material of a magnetic disk so as to have thermal expansion coefficient approximate to that of the magnetic disk. It is disclosed that when the magnetic disk is made of glass for instance, ceramics or glass whose thermal expansion coefficient is approximate to that of the magnetic disk is used. However, this publication is silent about a method for producing the spacer.

When the glass spacer is produced by casting molten glass into a mold as usual, a glass ring-shaped member, which has a small size and outer and inner peripheral surface, is difficult to be produced with fine precision. Additionally, the glass ring-shaped member thus molded needs to be annealed after molding in order to avoid deformation or damage caused by residual heat distortion. Further, both lateral surfaces as the contacting surfaces with a magnetic disk are polished, and besides, the inner and outer peripheral surfaces are also polished in many cases. The conventional glass spacer has an extremely low productivity and is costly since the operation after molding needs a lot of time and labor.

In the method for cutting out a glass ring-shaped member from a glass sheet, only about 30% of the glass sheet is utilized, and the remaining portion is discarded as a cullet since the ring-shaped glass is cut out from the glass sheet. As a result, this method has a low utilization rate of the glass sheet and is uneconomical. In order to cut out a small diameter ring from a thick glass sheet, cutting by a core drill is required as stated earlier since it is impossible to efficiently cut out that sort of ring by a cutter as in the case of cutting a normal glass sheet. Even if a core drill in a dual structure is used, it takes some time to cut out the ring. Additionally, the inner and outer peripheral surfaces thus cut need to be polished. The contacting surfaces with a magnetic disk need to be subjected to slight surface roughening since the contacting surfaces before surface roughening are too smooth to fixedly secure the magnetic disk against high-speed rotation. Cutting out from the glass sheet and polishing after it need a lot of time and labor, creating a problem in that the production costs are raised.

In the case of the ceramic spacer, which has been put into practice for a magnetic disk having a glass substrate, the spacer is made of a porous sintered compact. Even when the spacer is washed, there remains a problem of dust creation, which is demanded to be solved.

### SUMMARY OF THE INVENTION

It is an object of the present invention to solve these problems. In order to attain the object, a wide variety of development and research have been made about a method for preparing a glass spacer ring at low cost. The present invention is provided by finding that the object can be attained by using a glass tube satisfying certain requirements as a material and cutting the glass tube into a round slice.

The present invention provides a method for preparing a glass spacer ring for a magnetic disk, a is spacer ring and another product, which are, respectively, defined as follows:

1. A method for preparing a glass spacer ring for a magnetic disk, comprising providing a glass tube having a diameter and a wall thickness corresponding to a diameter and a width of a spacer ring, respectively; and forming the spacer ring by cutting the glass tube in a direction perpendicular or substantially perpendicular to a tubular axis thereof so as to correspond to a thickness of the spacer ring.

2. The method defined in item 1, further comprising providing a glass tube having a diameter and a wall thickness corresponding to a diameter and a width of a spacer ring, respectively;

forming the spacer ring by cutting the glass tube with a cutter, a diamond saw or a diamond drill in a direction perpendicular or substantially perpendicular to a tubular axis thereof so as to correspond to a thickness of the spacer ring.

3. A method for preparing a glass spacer ring for a magnetic disk, comprising providing a glass tube having a diameter and a wall thickness corresponding to a diameter and a width of a spacer ring, respectively; forming the spacer ring by cutting the glass tube with a cutter, a diamond saw or a diamond drill in a direction perpendicular or substantially perpendicular to a tubular axis thereof so as to correspond to a thickness of the spacer ring; and forming an electrically conductive film on the spacer ring so as to provide electrical conduction between upper and lower surfaces of the spacer ring after chamfering edges of an inner periphery and an outer periphery of the cut spacer ring.

4. The method defined in item 1 or 2, further comprising providing a wheel cutter or a diamond cutter, engraving a cutting line on an inner side of the glass tube with the cutter at a cutting interval corresponding to the thickness of the space ring, and heating an engraved portion of the glass tube from an outer side of the glass tube to cut the glass tube by heat shock.

5. The method defined in items 1 to 4, wherein the glass tube has a tolerance of plus or minus 0.2 mm or less in terms of diameter roundness and a tolerance of plus or minus 0.4 mm or less in terms of the wall thickness.

6. A glass spacer ring prepared by the method defined in any one of items 1 to 5.

7. A magnetic disk drive including the glass spacer ring defined in item 6.

### BRIEF DESCRIPTION OF THE DRAWING FIGURES

FIG. 1 is a perspective view of the glass spacer ring according to an embodiment of the present invention, partly shown in section;

FIG. 2 is a schematic view showing how to cut a glass tube in accordance with an embodiment of the present invention;

FIG. 3 is a schematic view showing how to cut a glass tube in accordance with another embodiment of the present invention;

FIG. 4 is a cross-sectional view of the spacer ring of an embodiment of the present invention; and

FIG. 5 is a cross-sectional view showing an example of a disk drive.

### DETAILED DESCRIPTION OF THE PREFERRED EMBODIMENTS

Now, preferred embodiments of the present invention will be described in detail in reference to the accompanying drawings.

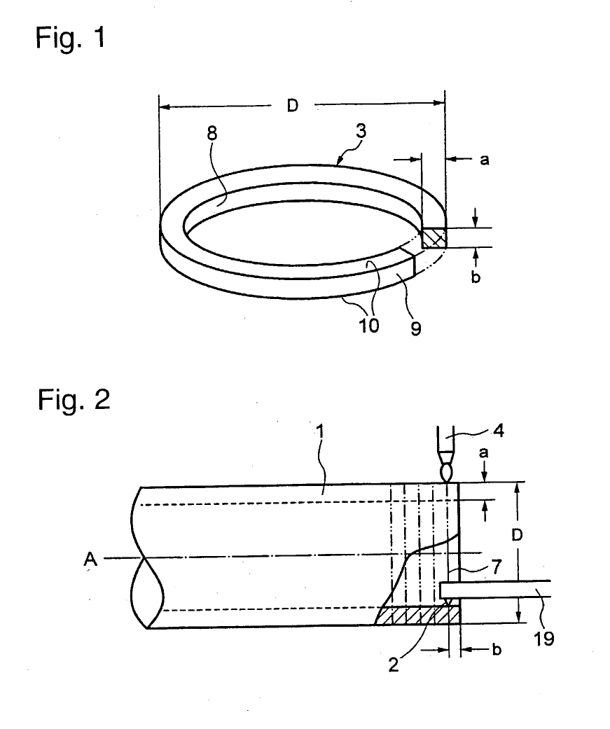

FIG. 1 is a perspective view of a glass ring 3 as a material for the spacer ring according to the present invention, which is partly shown in section. The glass ring 3 is prepared by cutting a glass tube into a round slice according to a method described later. The ring has a rectangular cross-sectional shape, which has upper and lower contacting surfaces 10, an inner peripheral surface 8, and an outer peripheral surface 9. Although the glass ring 3 is different from the spacer ring in terms of geometrical dimensions since the glass ring is an intermediate product, which has not been chamfered or does not have an electrically conductive film formed thereon, the glass ring has substantially the same dimensions as the spacer ring. Specifically, in FIG. 1, “D”, “a” and “b” corresponds to an outer diameter of the spacer ring, a width of the contacting surfaces of the spacer ring, and a thickness of the spacer ring, respectively. The dimensions of the glass ring are approximate to those of the spacer ring.

The method for preparing the glass ring 3 in accordance with a preferred embodiment of the present invention is shown in FIG. 2. As clearly shown in FIG. 2, this method is characterized in that a cutting line 7 is engraved with a cutter 2 along an inner periphery of the glass tube 1 in a direction perpendicular to a tubular axis A of the glass tube, i.e., so as to have a cut surface provided in a direction perpendicular or substantially perpendicular to the tubular axis A, and then a portion of the glass tube 1 with the cutting line provided therein is locally and externally heated with a burner 4 to cut the glass tube by heat shock. This cutting method with the heat shock utilized employs the same principle as a method, which has been known, in particular, to cut a glass tube. By repeating this cutting operation, the glass tube 1 is sequentially cut into round slices in a direction substantially perpendicular to the tubular axis A to obtain glass rings 3, one of which is shown in FIG. 1 as an example.

From this viewpoint, the outer diameter “D” and the wall thickness “a” of the glass tube 1 are the same as the outer diameter “D” and the width of the glass ring 3, i.e., the width “a” of the contacting surfaces 10 of the glass ring. The length of a cutting interval “b” conforms to the thickness “b” of the glass ring 3. It is inevitable that the glass tube 1 has the same inner diameter as the glass ring 3, though not shown. In other words, the glass tube 1, which has been preliminarily formed so as to have the diameters (the inner and outer diameters) and the wall thickness corresponding to the diameters and the width of the spacer ring 5, may be cut into a round slice by the cutting interval corresponding to the thickness of the spacer ring, thereby obtaining the glass ring 3. The glass tube that has the diameters and the wall thickness corresponding to the diameters and the width of the spacer ring means a glass tube that has the same dimensions as the spacer ring 5 or dimensions that are obtained by adding grinding allowances to the dimensions of the spacer ring. The cutting of the glass tube by the cutting interval corresponding to the thickness of the spacer ring means cutting of the glass tube 1 by the cutting interval, which is substantially the same dimension as the thickness of the spacer ring 5 or is obtained by adding a grinding allowance to the thickness of the spacer ring.

It is preferable that the tolerance of the roundness in the inner and outer diameters and the tolerance in the wall thickness of the glass tube 1 (allowable ranges for set values of the glass tube) are as small as possible. For example, the roundness of the inner and outer diameters is preferably 0.2 mm or less, or more preferably 0.05 mm or less, and the tolerance in the wall thickness is preferably plus or minus 0.4 mm or less, or more preferably plus or minus 0.2 mm or less. When the tolerance of the roundness and the tolerance of the wall thickness, respectively, exceed 0.2 mm and plus or minus 0.4 mm, it is impossible to enjoy advantages of the present invention since excessive loads are placed on the operation for shaping the inner and outer diameters of the glass tube to desired dimensions. When the production tolerance of the glass tube 1 is extremely small, and when the diameters and the wall thickness of the glass tube 1 are substantially the same as the dimensions of the spacer ring 5, it is possible to achieve the desired dimensional accuracy without grinding the inner peripheral surface 8 and the outer peripheral surface 9 of the glass ring 3. Even if the grinding operation is needed, it is possible to achieve the desired dimensional accuracy with minor grinding.

From this viewpoint, what is important to the present invention is to produce the glass tube so as to have high quality and excellent dimensional accuracy in the diameters and the wall thickness. When the glass tube has poor dimensional accuracy, it is impossible to enjoy the advantages of the present invention since the glass ring 3 needs greater grinding allowances. As the method for preparing the glass tube 1, there may be utilized several conventional methods, such as a runner method, a down-draw method and an up-draw method. Among the conventional methods, the runner method is preferable in terms of productivity and dimensional accuracy.

As the cutter 2, a wheel cutter made of super alloy, a diamond cutter or a diamond drill, which has been commonly used as a glass cutter, may be utilized without modification. Among these glass cutters, the super alloy wheel cutter, which rotates on a glass surface to engrave a cutting line thereon, is suited to cut the glass tube for the present invention from the viewpoint of engraving of the cutting line 7 in good fashion and repeatedly use subject to grinding, and another viewpoint. When the cutting line 7 is engraved on the inner surface of the glass tube with the cutter (the super alloy wheel cutter) 2, the cutter 2, which is mounted on a leading edge of a mounting rod 19, is pressed against the inner surface of the glass tube 1 to engrave the cutting line 7 while the glass tube 1 is rotated one turn with a constant speed without shifting in the direction of the tubular axis. Although this operation is a normal way, the cutter 2 may be moved along the inner peripheral surface of the glass tube 1 to engrave the cutting line 7 while the glass tube 1 is fixed.

As the burner 4 for providing heat shock to an engraved portion of the glass tube 1, there may be utilized a conventional burner, which has been used for cutting a glass tube by heat shock. After the cutting line 7 has been engraved on the glass tube 1, the engraved portion is locally heated from outside while the glass tube is being rotated. In the portion of the glass tube with the cutting line 7 engraved thereon, minor cracks have been formed in a direction perpendicular to the glass surface. When the engraved portion has a heat distortion effect created therein by heating, greater cracks are formed from the minor crack. The greater cracks thus formed expand toward a central layer of the glass tube 1 to break the glass tube along the cutting line 7, cutting the glass tube into a round slice in a direction perpendicular to the tubular axis “A”.

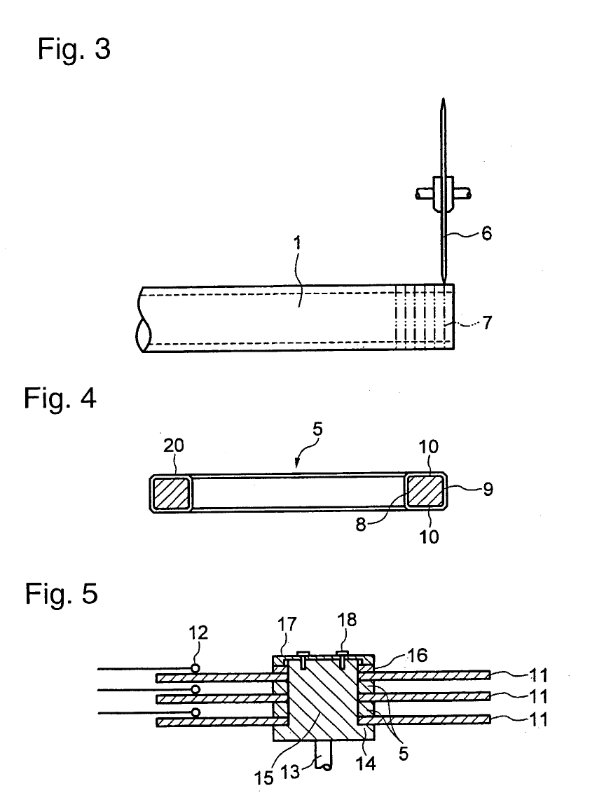

FIG. 3 shows another embodiment wherein the glass ring is cut into a round slice from the glass tube 1. In the method according to this embodiment, the glass tube 1 is cut with a diamond saw 6 in a direction perpendicular to the tubular axis thereof so as to correspond to the thickness of the spacer ring. Although the glass ring can be cut with high dimensional accuracy by this method, the cutting time is longer than the time required for cutting by heat shock since the cutting in this embodiment is made by the diamond saw 6. When a plurality of diamond saws are coaxially provided at required cutting intervals in the embodiment shown in FIG. 3, a plurality of glass rings may be simultaneously cut out.

Although the cutting is made by the external cutting edge of the diamond saw (saw having an external blade) 6 in a disk-like shape in the embodiment shown in FIG. 3, the cutting may be made by an annular diamond saw having an internal cutting edge (saw having an internal blade). Since the saw having an internal blade can be generally formed so as to have a greater saw diameter than the saw having an external blade, the saw having an internal blade can have the peripheral speed of the cutting edge increased accordingly, making the cutting speed faster. The saw having an internal blade can facilitate to simultaneously cut a plurality of glass tubes side by side or in a bundle since the saw can have a greater effective diameter and since the saw can be held at the peripheral portion, stabilizing the rotation.

In order that magnetic disks 11 are fixed by the spacer rings so as to avoid distortion during operation, it is preferable that the glass tube used for the present invention has such a thermal expansion coefficient that the difference between the glass tube and the glass substrates of the magnetic disks 11 is as small as possible in terms of thermal expansion coefficient. It is also preferable that the glass tube has such a thermal expansion coefficient that the difference between the glass tube and the stainless steel (SUS metal) as the materials for spacer ring mounting members, such as the mounting shaft 15 and the clamp 17 (see FIG. 5), is as small as possible in terms of thermal expansion coefficient. From these viewpoints, it is preferable that the glass tube 1 has a thermal expansion coefficient in a range from the thermal expansion coefficient of commonly used glass (about 70×10⁻⁷/° C.) to the thermal expansion coefficient of stainless steel (about 95×10⁻⁷/° C.), especially in a range from 75×10⁻⁷/° C. to 95×10⁻⁷/° C. When the glass tube 1 has a thermal expansion coefficient in one of the ranges, the difference between the spacer rings and the magnetic disks and the difference between the spacer rings and the mounting members can be made small in terms of thermal expansion coefficient, preventing the magnetic disks from suffering distortion, which may be a hindrance to proper operation.

For these reasons, e.g., soda lime glass, flint glass or aluminosilicate glass, which has a thermal expansion coefficient included in one of the ranges, is applicable in terms of the composition and the kind of the glass tube 1. Soda lime glass or flint glass is generally appropriate.

Next, explanation of how to chamfer the glass ring 3 (see FIG. 1) cut in a round slice from the glass tube 1 will be made. The edges of the inner peripheral surface 8 and the outer peripheral surface 9 of the sliced glass ring 3 are easily chipped by contact with something or during securing magnetic disks since the edges are sharp. There is a possibility that a sharp edge damages the magnetic film on a magnetic disk or breaks an electrically conductive film on the spacer ring to cause poor electrical conduction.

In order to cope with these problems, the edges may be chamfered so as to be tapered or curved. For example, when the outer peripheral surface 9 of the glass ring 3 shown in FIG. 1 is chamfered, a grindstone is pressed against the outer peripheral surface 9 to simultaneously chamfer the upper and lower edges, while the glass ring 3 is rotated. This operation is not shown in the drawings. Since excessive chamfering causes the area of the contacting surfaces 10 to be reduced more than necessary, it is preferable that the chamfering operation is normally carried out such that the chamfering length is 0.1 to 0.5 mm. When the inner peripheral surface 8 is also chamfered in the same way as the outer peripheral surface 9, the edges of the glass ring 3 are chamfered as shown in FIG. 4.

In a preferable embodiment of the present invention, when the glass ring 3 is subjected to the chamfering operation, the inner peripheral surface 8 and the outer peripheral surface 9 are polished to improve the dimensional accuracy of the inner diameter and the outer diameter (including the roundness). The polishing operation may be carried out along with the chamfering operation by using a grinding wheel having a grinding surface, which can chamfer the edges of a peripheral surface and polish the peripheral surface. The polishing operation may be usually carried out as a standard operation since the polishing operation does not need too much workload. When the glass tube 1 has such good production precision that the inner peripheral surface 8 and the outer peripheral surface 9 have dimensional accuracy included in one of the required range, it is sufficient to carry out only the chamfering operation.

It is preferable that the contacting surfaces of the glass ring 3 have a desired flatness and a desired surface roughness, and that the upper and lower contacting surfaces have a good parallelism therebetween. When the contacting surfaces have neither a good flatness nor a good parallelism, magnetic disks are likely to be subjected to distortion since it is difficult to uniformly secure the magnetic disks. Conversely, when the contacting surfaces 10 of the spacer ring 5 are as smooth as the surfaces of the magnetic disks, it is difficult to firmly secure the magnetic disks. In that case, there is a possibility that a slip is generated when the magnetic disks are rapidly rotated, or the magnetic disk drive is dropped. The magnetic disks need to be firmly secured with the spacer rings since an angular shift of a magnetic disk prevents the magnetic head for the magnetic disk from reading or writing information data correctly. From this viewpoint, it is preferable that the contacting surfaces 10 have the desired surface roughness.

However, it is difficult to provide the contacting surfaces 10 with the desired flatness and the desired surface roughness only by cutting the glass tube 1. Additionally, the upper and lower contacting surfaces 10 have no enough parallelism therebetween in some cases. From these reasons, it is normally preferable that the flatness, the surface roughness and the parallelism of the contacting surfaces 10 of the glass ring 3 are improved by polishing the contacting surfaces 10 before carrying out the chamfering operation. In order to secure the magnetic disks so as to be free from distortion, it is preferable that the flatness of the contacting surfaces 10 is 2 μm or less, and that the parallelism of the upper and lower contacting surfaces 10 is 5 μm or less. It is also preferable that the surface roughness is in a range from 0.3 to 2 μm in terms of Ra roughness. When Ra roughness is less than 0.3 μm, it becomes difficult to firmly secure the magnetic disks. When Ra roughness is greater than 2 μm, the flatness degrades, which is not preferable.

The glass ring, which has been chamfered or polished as stated earlier, has a structure wherein an electrically conductive film is formed on the ring such that static electricity charged on a magnetic disk is discharged outside. FIG. 4 is a cross-sectional view of the spacer ring 5, which has an electrically conductive film 20 formed thereon. The electrically conductive film may be formed by depositing a metallic material or a metallic oxide, such as SnO₂, ITO, Au or Cu by use of a dip method, a spray method, a CVD method, a PVD method or another method. The electrically conductive film is normally formed from SnO₂ or ITO (In₂O₃ with Sn doped therein) by use of a CVD method.

Although the electrically conductive film 20 is normally formed on the entire surface of the spacer ring 5 as shown in FIG. 4, the electrically conductive film may be partly formed as long as the static electricity can be discharged outside through the mounting shaft 15 (see FIG. 5). When the electrically conductive film is formed on each of the upper and lower contacting surfaces 10 in contact with magnetic disks 11, it is sufficient to provide an electrically conductive film to only one of the inner and outer peripheral surfaces 8 and 9, e.g., the inner peripheral surface 8, for electrical conduction between the electrically conductive films on the upper and lower contacting surfaces 10. It is preferable that the electrically conductive film has an electrical resistance of 10 MΩ or less. When the electrical resistance is greater than 10 MΩ, there is a possibility that static electricity charged on a magnetic disk cannot be discharged outside in reliable fashion. There is no limitation to the thickness of the electrically conductive film, though the thickness varies depending on the material of the film. It is preferable that the thickness is normally about 0.02 to 0.2 μm.

The spacer ring according to the present invention is also applicable to a shim interposed between the top magnetic disk and the clamp in a magnetic disk drive without being modified or with only the thickness changed. The spacer ring according to the present invention covers that sort of shim as well.

### EXAMPLE

A glass tube was formed so as to have an outer diameter 24.1 mm plus or minus 0.5 mm and a wall thickness of 2.4 mm plus or minus 0.2 mm, using a device for preparing a glass tube for a fluorescent lamp by a runner method. The glass tube thus formed was cut in a length of about 1 m. The cut glass tube had a cutting line engraved on the entire inner peripheral surface thereof in a direction perpendicular to the tubular axis at a location away from an end thereof by 2 mm, using a superalloy wheel. Then, the glass tube had a portion with the cutting line engraved thereon heated by a burner from outside to be further cut by heat shock. Then, the cutting operation was repeated to prepare plural glass rings.

The glass rings that were cut in round slices as stated earlier had the inner and outer peripheral surfaces subjected to edge chamfering along with surface polishing by a chamfering machine. Thus, the glass rings were formed so as to have an outer diameter of 23.6 mm, an inner diameter of 20 mm and a chamfering length of 0.15 mm. Then, the glass rings had the upper and lower cut surfaces (corresponding to the contacting surfaces 10 shown in FIG. 1) polished to reduce the thickness to 1.67 mm and provide the upper and lower polished surfaces with a parallelism of 2 μm, a flatness of 0.7 μm and a surface roughness (Ra) of 0.3 μm. By washing the glass rings, and then depositing SnO₂ on the glass rings to form an electrically conductive film of SnO₂ having a film thickness of 0.05 μm and an electrical resistance of 20 kΩ on the entire surfaces thereof, spacer rings were obtained.

When the glass spacers thus formed were utilized to fabricate a magnetic disk drive as shown in FIG. 5, and when the magnetic disk drive was driven, it was confirmed that the glass spacers were able to firmly secure the magnetic disks without distortion, and that the static electricity generated during driving were discharged outside through the spacer rings to prevent static electricity charges from being built up on the magnetic disks.

In accordance with the present invention, the glass rings can be prepared by cutting the glass tube into round slices as stated earlier. The method according to the present invention is more productive than the conventional casting method. The method according to the present invention can provide the glass rings having high quality in effective fashion and at low cost.

In the case of the conventional method that the glass rings are cut out from a glass sheet with a core drill, it takes a long time for the cutting operation, and the usability of the glass sheet is extremely low since the core portion and the outer peripheral portion are discarded after the cutting operation. Additionally, excessive loads are placed on the operation for the polishing operation after the cutting operation in terms of cutting accuracy. On the other hand, in accordance with the present invention, the glass rings are prepared in round slices from the glass tube. The usability of the glass tube is extremely high. The glass rings can be easily prepared in the same dimensions as or in approximate dimensions to the spacer rings by using the glass tube that has a diameter and a wall thickness corresponding to a diameter and a width of the spacer rings, respectively. Thus, the loads for the polishing operation can be decreased, and the spacer rings having high quality can be provided at low cost.

Further, when the glass tube has good production precision, the inner and outer peripheral surfaces of the glass rings can be formed from undamaged and smooth fire-polished surfaces of the glass tube since the glass rings are prepared by being cut into round slices from the glass tube.

The entire disclosure of Japanese Patent Application No. 2002-074770 filed on Mar. 18, 2002 including specification, claims, drawings and summary is incorporated herein by reference in its entirety.

What is claimed is:

1. A method for preparing a glass spacer ring for a magnetic disk, comprising:
providing a glass tube having a diameter and a wall thickness corresponding to a diameter and a width of a spacer ring, respectively; and
forming the spacer ring by cutting the glass tube in a direction perpendicular or substantially perpendicular to a tubular axis thereof so as to correspond to a thickness of the spacer ring.

2. The method according to claim 1, further comprising:
providing a glass tube having a diameter and a wall thickness corresponding to a diameter and a width of a spacer ring, respectively;
forming the spacer ring by cutting the glass tube with a cutter, a diamond saw or a diamond drill in a direction perpendicular or substantially perpendicular to a tubular axis thereof so as to correspond to a thickness of the spacer ring.

3. A method for preparing a glass spacer ring for a magnetic disk, comprising:
providing a glass tube having a diameter and a wall thickness corresponding to a diameter and a width of a spacer ring, respectively;
forming the spacer ring by cutting the glass tube with a cutter, a diamond saw or a diamond drill in a direction perpendicular or substantially perpendicular to a tubular axis thereof so as to correspond to a thickness of the spacer ring; and
forming an electrically conductive film on the spacer ring so as to provide electrical conduction between upper and lower surfaces of the spacer ring after chamfering edges of an inner periphery and an outer periphery of the cut spacer ring.

4. The method according to claim 1, further comprising providing a wheel cutter or a diamond cutter, engraving a cutting line on an inner side of the glass tube with the cutter at a cutting interval corresponding to the thickness of the space ring, and heating an engraved portion of the glass tube from an outer side of the glass tube to cut the glass tube by heat shock.

5. The method according to claim 1, wherein the glass tube has a tolerance of 0.2 mm or less in terms of diameter roundness and a tolerance of plus or minus 0.4 mm or less in terms of the wall thickness.

6. A glass spacer ring prepared by the method defined in claim 1.

7. A glass spacer ring prepared by the method defined in claim 2.

8. A glass spacer ring prepared by the method defined in claim 3.

9. A magnetic disk drive including the glass spacer ring defined in claim 6.

10. A magnetic disk drive including the glass spacer ring defined in claim 7.

11. A magnetic disk drive including the glass spacer ring defined in claim 8.
